(19) United States
(12) Patent Application Publication
(10) Pub. No.: US 2012/0164239 A1
(43) Pub. Date: Jun. 28, 2012

(54) COMPOSITION AND METHOD FOR TREATING WOOD-BASED MATERIAL AND WOOD-BASED MATERIAL TREATED WITH COMPOSITION

(76) Inventors: Juha Estakari, Veikkola (FI); Toivo Mertaniemi, Oulu (FI); Jari Jussila, Pudasjarvi (FI); Juha Kuusisto, Siilinjarvi (FI); Reijo Saunamäki, Espoo (FI); Norberto Mancuso, Buenos Aires (AR)

(21) Appl. No.: 13/130,763

(22) PCT Filed: Nov. 25, 2009
(86) PCT No.: PCT/FI09/50955

§ 371 Date: Aug. 12, 2011

(30) Foreign Application Priority Data
Nov. 25, 2008 (FI) 20080634

(51) Int. Cl. A01N 59/06; A01N 57/00; A01N 37/00; A01N 37/44; A01P 7/04; A01P 15/00; A01P 3/00; B05D 7/06; B05D 1/18; B05D 1/02; B05D 1/28; B05D 3/00; B27M 1/08; C09D 7/12; C09D 5/14; C09D 5/18; A01N 57/20

(52) U.S. Cl. 424/685; 424/682; 514/108; 514/114; 514/557; 514/558; 514/561; 427/440; 427/427.7; 427/429; 427/372.2; 144/364; 106/287.2; 106/287.17; 106/15.05; 106/18.14; 106/18.21

(57) ABSTRACT

A composition for treating wood-based material including at least one C₁-C₇ monocarboxylic acid salt or C₁-C₇ monocarboxylic acid or a mixture thereof as active agent against deteriation of wood. The composition also includes alkyd emulsion of high unsaturated fatty acid content and/or aluminum ion containing compound in the form of polyaluminum formate in a same aqueous liquid carrier as the C₁-C₇ monocarboxylic acid salt or C₁-C₇ monocarboxylic acid or a mixture thereof.

### FIELD OF THE INVENTION

The invention relates to a composition and a method for treatment of wood-based materials for the purpose of improving the preservability and other properties of the materials. The main purpose of the invention is to provide a composition and method for preparing wood-based material, in which the composition increases the solubility of the wood preservative ingredients (e.g. coloring agents or pigments) into the wood-based material, improves the distribution gradient of the those ingredients in treated wood-based material and reduces the preservative leaching out of the wood-based material. The composition according to the invention is readily absorbed in very large amounts into wood-based material and is subsequently retained in the wood-based material also.

### BACKGROUND OF THE INVENTION

The inhibition of biological decay of wood and the improvement of fire resistance and water resistance of wood as well as maintaining dimensional stability of wood are key factors for increased use of wood-based materials as construction material.

Wood microbes are responsible for the biological decay of wood. Surface moulds and blue stain fungi utilize the contents of a dead vegetable cell, whereas brown and white rot fungi, actinobacteria and soft rot fungi are capable of decomposing the lignified cell wall of wood cells. Certain insects, especially termites in warmer climates, can also be regarded as biological decomposers of wood.

Publication WO 03/002318 discloses the uses of potassium formate and calcium formate in aqueous solutions for preserving wood, particularly against wood-rotting fungi and termites. WO 06/072672 in turn discloses a composition for treating wood containing formate together with sorbate and/or benzoate dissolved in an aqueous liquid carrier.

Publication EP 0 641 275 B1 discloses the use of chelating agents (i.e. complexing agents) in aqueous solutions for preserving wood. However, chelating agents are associated with the disadvantage that the compound washes easily out of the wood.

Publication WO 0123154 A1 discloses the use of chelating agents together with siloxane derivatives and fluoroalkyl polymers for improving the water-repellence of the treated wood material. It was claimed that the composition forms in the surface structures of materials a water-repellent film which prevents the penetration of water molecules of the lignocellulose-based material.

Potassium and calcium formate and chelating agents are known for their effect of inhibiting the growth of wood-rotting fungi, when their aqueous solutions are used for the treatment of wood. Their advantage is non-toxicity compared with, for example, conventional CCA (chromated copper arsenate) impregnation methods.

Potassium and calcium formate are biodegradable also, and the wood treated with them can be, for example, disposed of without environmental or safety problems.

One advantage of potassium formate, calcium formate and chelating agents is their good solubility in water, but a disadvantage due to this is their easy leaching from the wood. Other water-soluble salts of formic acid or other organic acids and even the commonly used borax salt wood preservatives suffer from the same disadvantage when wood-based material is impregnated with them.

It is an aim of the invention to provide a composition for treating several materials that
is safe (not harmful) to the working persons
is environmentally benign
is absorbed by or penetrates well all different kinds of wooden materials, but remains in the wood substantially without leaching out,
preserves the materials against biological decay,
protects the material against termites and insects,
protects the wood from dimensional and color changes and cracking,
improves the fire resistance of the materials, and
is not harmful for the structure of the materials after the treatment, even in long-term use.

### SUMMARY OF THE INVENTION

In this context, the wood, for which the composition is intended, refers to all materials and products that contain wood and similar lignocellulose-based material, including raw timber, sawn timber, wooden building materials and elements, and various finished wood products (round logs, all sawn timber, such as boards, planks and laths, elements with a large surface area, such as plates, panels, blocks, wall elements, etc., furniture, outdoor furniture, and other wooden objects). The wood to be treated may also be present in fixed structures, particularly outdoors (wooden buildings, fences, racks, poles, bridges, piers, etc.). Wood also refers to a converted wood product that contains the original structure of wood (for example, wood material that has been ground or chipped and reworked).

The aqueous treatment composition according to the invention forms a fluid composition that can be entered at least partly in the wood or other materials by a variety of methods. In its simplest form, it is an aqueous solution of a salt of an organic acid, especially a formate, which contains alkyd emulsion and/or aluminum ions containing compounds. It can be absorbed in the material to be treated throughout or in a certain depth from the surface, for example by impregnation, immersion, spraying, steaming (atomizing) or brushing. Thanks to the many alternatives, the treatment can be implemented in a suitable step in the processing of the material, for example during the final drying of the wood. The physical properties (such as viscosity) of the composition may be adjusted according to the method and need of treatment. It is possible to heat the preservative composition according to the invention, and/or to use an elevated temperature in the process, which improves the absorption further. The use of negative pressure or overpressure, known from conventional CCA impregnation, also improves the absorption. In general, the composition according to the invention is suitable for use in all the conventional ways of impregnating wood, including pressure impregnation. However, the environmental safety of the composition offers many other possibilities which have been impossible to implement with more toxic compositions.

To achieve the aims of the invention, the composition is primarily characterized in what will be presented in the characterizing part of the appended claim 1. The water-based composition according to the invention contains at least one salt of organic acid (monocarboxylic acid C₁-C₇) or organic acid (monocarboxylic acid C₁-C₇) as active wood-protecting agent and solvent-free alkyd emulsion based on unsaturated fatty acids and/or aluminum ion containing compounds in the form of basic aluminium polyformate (polyaluminium formate).

It has been found that an alkyd emulsion containing high proportion of unsaturated “drying” fatty acids in its polymer structure and/or aluminum ion containing compounds in the form of polyaluminium formate prevent effectively the leaching out of wood-protecting organic acid salts, especially formates, when used in the water-based treatment composition together with the organic acid salt, the active agent of the composition. The alkyd emulsion increases the solubility of coloring agents into the wood-based material as well as also improves the distribution gradient of those ingredients in the treated wood-based material.

Water-based means that all components are dispersed or dissolved in water, which acts as carrier substance for bringing the components into the wood structure. Solvent-free means that the alkyd emulsion component needs no organic solvent for mixing it uniformly in the composition.

Because of its active agent, the composition inhibits efficiently the growth of surface mould and blue stain fungi as well as the decay of wood. It also keeps off pest insects and termites and increases the fire resistance of the treated material. Moreover, the composition inhibits dimensional and color changes in wood and the cracking of wood during storage and use. The composition is neutral or slightly alkaline, preferably 7-10, which is beneficial for the treatment of especially wood material. Acidic wood preservatives will deteriorate the wood structure and corrode e.g. the metallic material used in the wooden construction.

The composition according to the invention is prepared by dissolving and dispersing the above-mentioned agents, organic acid salt (monocarboxylic acid C₁-C₇ salt) or organic acid (monocarboxylic acid C₁-C₇ or mixture thereof) and alkyd emulsion of high fatty acid content and/or aluminum ion containing compounds in water and possibly also adding other auxiliary agents and additives depending on the use of the composition, which will be discussed later on.

In the composition, the active agent, the formate, is a formate of a monovalent or divalent cation or aluminum. The mono- or divalent cations are selected from the group of alkali metals, alkali earths, ammonium, copper, and zinc. The cation of the formate may be one of the following: K, NH₄, Na, Cs, Ca, Mg, Al, Cu, Zn, ammonium or a mixture thereof. Preferably, the cation of the formate is one of the following: ammonium, K, Na, Ca and Mg.

Most preferably, the cation is calcium (Ca). Calcium formate is only slightly hygroscopic and does not readily absorb water when the treated wood-based material is gets in contact with moisture. Calcium formate is easy to handle and use also.

If the formate is calcium formate, its content in the solution may be 0.5 to 20 wt-% or more depending on the used solubility agent aid. A part of the calcium formate can be replaced, particularly by calcium sorbate or sorbic acid or ammonium formate or formic acid.

The preferable composition containing an alkali metal formate and alkyd emulsion of high fatty acid content is one in which the formate is calcium formate in a content of 1 to 10 wt-% and in which the alkyd emulsion (e.g. Synthalat AEM 700 TC where the amount of fatty acid part is 55 wt-%) is in a content of 0.05 to 10 wt-%, preferably 0.1 to 5 wt-%.

In one embodiment of the present invention the treating composition contains agents, such as magnesium, calcium, zirconium, zirconyl, aluminum and/or silicate ions or compounds such as aluminium or zirconium salts of carboxylic acids such as aluminium triformate, aluminium basic formate, polyaluminium formate, or aluminium or zirconium salts of hydroxycarboxylic acids or aluminium or zirconium salts of polyhydroxycarboxylic acids or aluminium or zirconium salts of mono-, di-, and polycarboxylic acids such as basic aluminium polyformate or aluminium or zirconium salts of inorganic acids such as aluminium or zirconium chloride, sulphate, or phosphate or aluminium and or zirconium chelates of amino acid, amino carboxylic acids and/or phosphonates or their salts or any mixture thereof.

The most preferable composition containing alkali metal formate and aluminum ion containing compound is one in which the formate is calcium formate in a content of 1 to 10 wt-% and in which aluminum ion containing compound is basic aluminum polyformate (where the aluminum ion content is 1.0 to 7.0 wt-%) in a content of 0.01 to 30 wt-%, preferably 0.5 to 15 wt-%. Basic aluminium polyformate, also known as polyaluminium formate, is a compound where aluminium is in excess of the stoichiometric amount, and it is different from aluminium triformate where Al and formate are in stoichiometric proportions.

In still another embodiment the composition further contains boron (boric acid or its borax salt) or complexing agent (i.e. chelating agents) capable of binding transition metals as an auxiliary wood preservative aid.

The boron may be applied in several forms, e.g. as normal boron in aqueous solution, borate, or glycol borate to gain extra penetration. Typically 10 wt-% solution of boric acid is applied by pressure impregnation. Boron has also biocide activity, e.g. against mold, and it is also effective against termites and the like as well as against fire.

The complexing agent used as an auxiliary wood preservative aid is in particular an aminopolycarboxylic acid or salt thereof, a hydroxy acid or a salt thereof, or a phosphonate (i.e. organic phosphonate i.e. organophosphate) or a mixture thereof. The complexing agent used is preferably ethylenediaminetetra-acetic acid (EDTA), nitrolotriacetic acid (NTA), n-hydroxyethyl-ethylenediaininetriacetic acid (HEDTA), diethylenetriaminepentaacetic acid (DTPA), ethylediamine-di-o-hydroxyphenylacetic acid (EDDHDA), diethanolglycine (DEG), ethanoldiglycine (EDG) or salt thereof or 1-hydroxyethylidene,1,1-diphosphonic acid (HEDP), ethylenediaminetetramethylenephosphonic acid (EDTMP), diethylenetriaiminepentamethylenephosphonic acid (DTPMP) or salt thereof or a mixture thereof.

In wood preservation applications the complexing agents are typically used in an amount of 0.01 to 5.0 wt-% as a fungicide (e.g. EP 0 682 091 A2). The preferable composition containing an alkali metal formate, alkyd emulsion and the complexing agent (e.g. 1-hydroxyethylidene,1,1-diphosphonic acid i.e. HEDP) as wood preservation aid is in which the formate is calcium formate in a content of 1 to 10 wt-%, in which the alkyd emulsion is in a content of 0.1 to 5 wt-%, and in which HEDP is in a content of 0.05 to 1 wt-%.

The fire resistance can be improved further, for example, by adding the following substances into the composition containing one or several carboxylic acid salts, especially formate, and the alkyd emulsion:

1) Magnesium, calcium, aluminum or silicate ions, or mixtures thereof;
2) Any known fire retarding chemicals based on phosphorus and nitrogen, such as, for example, diammonium hydrogen phosphate, mono ammonium dihydrogen phosphate, ammonium polyphosphate, phosphonates [i.e. organic phosphonate i.e. organophosphate such as 1-hydroxyethylidene,1,1-diphosphonic acid (HEDP), ethylenediaminetetramethylenephosphonic acid (EDTMP), diethylenetriaiminepentamethylenephosphonic acid (DTPMP) or their salts], urea, or urea phosphate, or mixtures of these.

The total content of magnesium, aluminum and/or silicate ions is preferably 0.1 to 20 wt-%.

The preferable composition containing an alkali metal formate, alkyd emulsion and phosphonate (e.g. HEDP) as fire retarding aid is in which the formate is calcium formate in a content of 1 to 10 wt-%, in which the alkyd emulsion is in a content 0.1 to 5 wt-% and in which HEDP is in a content of 5.0 to 40 wt-%.

In still another embodiment the composition according to invention may also contain surfactants by means of which the distribution, the penetration of the wood preservative comes even more efficient. The use of surfactants also increases the stability of the wood preservative and facilitates the dissolving of the used alkyd emulsion based on unsaturated fatty acids and/or aluminum ion containing compound into wood preservative i.e. prevents the phase separation in the ready made wood preservative.

Surfactants are wetting agents that lower the surface tension of a liquid, allowing easier spreading, and lower the interfacial tension in between two liquids.

A surfactant can be classified by the presence of formally charged groups in its head. A non-ionic surfactant has no charge groups in its head. The head of an ionic surfactant carries a net charge. If the charge is negative, the surfactant is more specifically called anionic; if the charge is positive, it is called cationic. If a surfactant contains a head with two oppositely charged groups, it is termed zwitterionic.

Some commonly encountered surfactants of each type include
Ionic
   a Anionic (based on sulfate, sulfonate or carboxylate anions)
      Perfluorooctanoate (PFOA or PFO)
      Perfluorooctanesulfonate (PFOS)
      Sodium dodecyl sulfate (SDS), ammonium lauryl sulfate, and other alkyl sulfate salts
      Sodium laureth sulfate, also known as sodium lauryl ether sulfate (SLES)
      Alkyl benzene sulfonate
      Soaps, or fatty acid salts
   Cationic (based on quaternary ammonium cations)
      Cetyl trimethylammonium bromide (CTAB) a.k.a. hexadecyl trimethyl ammonium bromide, and other alkyltrimethylammonium salts
      Cetylpyridinium chloride (CPC)
      Polyethoxylated tallow amine (POEA)
      Benzalkonium chloride (BAC)
      Benzethonium chloride (BZT)
   Zwitterionic (amphoteric)
      Dodecyl betaine
      Cocamidopropyl betaine
      Coco ampho glycinate
Nonionic
   Alkyl poly(ethylene oxide)
   Alkylphenol poly(ethylene oxide)
   Copolymers of poly(ethylene oxide) and poly(propylene oxide) (commercially called Poloxamers or Poloxamines)
   Alkyl polyglucosides, including Octyl glucoside and Decyl maltoside
   Fatty alcohols including Cetyl alcohol and Oleyl alcohol
   Cocamide MEA, cocamide DEA
   Polysorbates (Tween 20, Tween 80), Dodecyl dimethylamine oxide

The preferable surfactant is anionic such as described in patent WO 95/14071.

The preferable composition containing an alkali metal formate or formic acid, alkyd emulsion, phosphonate (e.g. HEDP or diammonium hydrogen phosphate or mono ammonium dihydrogen phosphate or mixture thereof) as fire retarding aid and surfactant is in which the formate is ammonium formate in a content of 1 to 30 wt-% or as formic acid in a content of 1-28 wt-%, in which the alkyd emulsion is in a content 0.1 to 5 wt-%, in which HEDP or diammonium hydrogen phosphate or mono ammonium dihydrogen phosphate or mixture thereof is in a content of 5.0 to 40 wt-% and in which surfactant is in a content of 0.01 to 30 wt-%, preferably 0.05 to 5 wt-%.

According to a preferred embodiment, PHMG is used in the composition. Polyhexamethyleneguanidine (PHMG) acts as environmentally safe biocide. Further, the drying properties of PHMG are very good which speeds up the treating process. Also other commercial biocides may be used, such as Tanagard, but they may be very harmful and poisonous. The preferable composition containing PHMG is in a content of 0.001 to 5.0 wt %. Other polymeric guanidine or polymeric compounds are also included. PHMG or other polymeric guanidine compounds are preferably used together with polyaluminium formate (basic aluminium polyformate) in the composition.

The most preferable composition containing alkali metal formate and aluminum ion containing compound is one in which the formate is calcium formate in a content of 1 to 10 wt % and in which aluminum ion containing compound is basic aluminum polyformate (where the aluminum ion content is 4.0 to 7.0 wt-%) in a content of 0.01 to 30 wt-%, preferably 0.5 to 15 wt-% and in which PHMG or other polymeric guanidine or polymeric compounds is in a content of 0.001 to 10.0 wt-%.

According to the preferred embodiment, oxidizing chemicals such as hydrogen peroxide and chlorate is used in the composition. Oxidizing chemicals assist the removal of dirt e.g. Ca-oxalate, Ca-carbonate, grease and fat from the surface of the treated wood item. The preferable composition containing oxidizing chemical such as hydrogen peroxide is in a content of 1 to 30 wt-%.

Furthermore, it is possible to use other salts of organic acids. In addition to the above-mentioned formates, the same aqueous carrier may contain, as such an auxiliary salt, particularly salts of C₂-C₈ monocarboxylic acids, such as acetate, lactate, citrate, oxalate, propionate, sorbate or benzoate as auxiliary agents supplementing the effect of the formate. However, the invention also encompasses the use of any of these salts in place of formate, provided that the salt has wood-preserving effect, because the alkyd emulsion will work even when it is used in the composition together with one or several of these water-soluble salts. For example sorbate and benzoate are known to be effective against surface mould, whereas formate is known to be particularly effective against blue stain fungi and to preserve the wood against termites, which is advantageous in countries where the termites cause damage in wooden structures.

Another advantageous property that should be mentioned of the composition according to the invention is the fact that it does not contain heavy metals classified to be particularly hazardous on the basis of toxicity, such as chromium or arsenic, which are known from compositions of prior art; nor does it contain lead, mercury or cadmium. However, it is possible that the composition contains heavy metal residues from the raw materials used in the preparation, for example from the water used as a carrier for the composition. However, the content of these is infinitesimal when compared with compositions in which heavy metals have been added as active agents. The composition according to the invention contains salts of natural organic acids which are harmless to the environment (for example formic acid, sorbic acid, benzoic acid, acetic acid, propionic acid), preferably together with alkali metals or alkali earths or ammonium.

The composition according to the invention may also contain aluminum, copper or zinc ions, by means of which the preservability of wood materials can be made more efficient but which are much safer to use than the above-mentioned hazardous heavy metal compounds. To include copper and/or zinc ions, which increase the anti-fungal effect, in the composition, it is possible to use copper and/or zinc salts of formate, sorbate and/or benzoate or, for example, copper sulfate or zinc sulfate. The aluminum can be included in the form of aluminum sulfate, polyaluminium sulfate, aluminum chloride, polyaluminium chloride, aluminum oxide, aluminum hydroxide, or aluminum formate (aluminum triformate or polyaluminium formate).

Furthermore, the pH of the composition according to the invention is primarily neutral or slightly alkaline, because instead of acids it contains salts of formic acid and/or acetic acid, the pH being higher than 4, advantageously higher than 6, when measured directly from the solution. For example, strongly acidic wood-preserving or fire-retarding compositions easily damage the structure of wood in course of time. Similarly, they are harmful if metallic construction materials (for example, nails, screws) are used in connection with such wood, due to the susceptibility of rusting. In some cases, an acidic component may be added to adjust the pH to a value of 6 or more, which is still higher than the pH of known compositions based on acids. The pH is in the range from 4 to 12, preferably in the range from 6 to 11, the ideal situation being in the range from 7 to 10, measured directly from the solution.

The treatment solution according to the invention may contain known buffer chemicals (for example borax, carbonate, phosphate, etc.) as needed. The content of the buffer chemical ranges from 0.001 to 5.0 wt-%.

The method for treating wood according to the invention comprises bringing the wood in contact with said composition. Depending on the physical properties of the composition, the result is impregnation of the wood to a certain depth, surface treatment of the wood, or a combination of these.

The action of the treatment solution according to the invention is based on the chemical modification of the wood with formate and alkyd emulsion. Small-sized carboxylic ions (such as, for example, formate) penetrate into the wood and form corresponding salts in the wood. Together with the alkyd emulsion used as binding agent, possibly together with calcium, magnesium, aluminum and/or silicate, the carboxylic ions according to the invention inhibit the absorption of water and moisture, which are essential for the organisms that biologically decompose wood and also for all biological action, into the wood or into the cell system of the wood.

The invention is suitable for the treatment of both processed timber and raw timber, and the treatment can be given either at wood storage sites or in a separate processing mill for timber, wherein the treatment composition and the wood can be brought into contact in a variety of ways. Similarly, the invention is suitable for the preservation of stationary structures already erected, particularly outdoors, wherein primarily spraying and brushing of the surfaces can be used. It should be noted that thanks to the safety of the composition, it can be used for the treatment of erected wooden structures in their locations of use without particular safety measures.

The solution containing formate can be stored in unheated rooms also during winter time, because it has good resistance to freezing, in the case of strong solutions containing potassium formate (50 wt-%) down to a minimum of −50° C. Thanks to these properties, it is possible to prepare, for example, a solution that is more concentrated than the above-described ready-to-use solutions, i.e. a concentrate that is suitable for storage at cold temperatures below 0° C. and which can be diluted before the use. In the preparation of such a concentrate, one should naturally take into account the solubility of the substances and in its storage recommendations the freezing point of the resulting solution.

The invention suits particularly well for treatment processes requiring good penetrability into wood, such as impregnation. The composition can be entered into the wood, for example, in the known pressure impregnation process, in which the wood is at first kept under negative pressure to remove water from its inside, after which the composition is brought into contact with the wood and its penetration into the wood is enhanced by overpressure.

The solution according to the invention may contain various additives, depending on the use. If the composition is to be used for surface treatment, coloring agents, such as organic coloring agents or pigments, may be added into it if the wood surface to be treated should also be given a visual change in the way of painting. In this case, for example CMC (carboxymethyl cellulose) can be used as an adhesive, which at the same time acts as a rheological auxiliary agent. The pigments and organic coloring agents are preferably free of heavy metals. For example, known iron oxide pigments can be used as the pigment. The physical properties of the compositions to be brushed onto the surfaces can also be selected on the basis of the use; in other words, it can be more viscose than the composition intended for impregnation, which should penetrate well into the wood. However, it should be noted that also when brushable compositions are used, some penetration of the active agents into the wood takes place (of the order of millimeters), also with viscose compositions.

The invention is also suitable for objects which are not completely made of wood but, for example, a combination of wood and another material, even construction materials such as concrete, stone and plastic. The invention is suitable for protecting houses, warehouses and living areas against insects, termites and fungi when simply sprayed or brushed on the protected surfaces.

Similarly, the invention is suitable for wood from different tree species, for example pine, which is conventionally treated with CCA, for example by pressure impregnation. However, the invention is particularly well suited for tight grained wood material which is difficult to impregnate with CCA, such as spruce, if the penetration properties of the composition are adjusted to be suitable. In this way, the composition whose efficiency is at least comparable to that of CCA but which is safer for the environment can be used to improve the preservation of such types of wood which have previously not been preservable in a proper way.

The invention makes it possible to treat wood materials in a light and cost-efficient way, and the treatment can be easily included in other present-day steps of wood treatment. The process may be one step in a processing line of timber or wooden objects comprising successive steps. The composition according to the invention is also pleasant to handle, because it does not emit strongly irritating odors.

In the following, practical examples will be given of methods how the treatment composition can be used for the treatment of wood and how the treatment can be integrated in a wood material processing line in mills for wood processing.

### 1) Pressure Impregnation

A conventional method for entering great amounts of impregnation substance in wood, and thereby providing the most effective treatment by means of different steps (negative pressure and overpressure, elevated temperature). By this method, the best penetrability of compositions is obtained, and the wood can normally be impregnated to the core. The composition according to the invention has a very good penetrability, wherein it is possible to reduce the negative pressures/overpressures used in conventional CCA impregnation and thereby to improve the cost-effectiveness of the process. Also, a tighter-grained type of wood, such as spruce, can be pressure impregnated with the composition according to the invention, which has not been possible with conventionally used substances.

### 2) Immersion Impregnation

The penetrability of the composition according to the invention is good, and in some cases, mere immersion impregnation is also possible. This method is simple but it requires separate immersion basins and is carried out in batch processes, like the pressure impregnation.

### 3) Spraying

The composition according to the invention can be sprayed onto the surface of wood, for example, in connection with the planning of sawn timber. In this way, preservation against microorganisms can be achieved during storage and delivery before a surface treatment (painting etc.) later on.

### 4) Painting or Other Surface Treatment Line

The composition according to the invention may also be added into the wood in connection with a painting or another surface treatment line. From a paint dosing tank, a wooden board can be impregnated with the solution under overpressure or negative pressure through a separate painting unit. Depending on the pressure and the speed of the line, relatively good penetrability and thereby a reasonable resistance to weather and fire can be achieved by this method.

### 5) Drying of the Wood and the Control of Final Moisture Content

In the processing of timber in sawmills, it is more and more important that the final moisture content of the wood is suitable to prevent cracking and dimensional changes, as well as to prevent too good a substrate from forming for biological life. In connection with the drying, the tree often dries to a moisture content that is lower than desired. At the end, the moisture content can be adjusted, for example, by a technique based on spraying with water. In this step, it is very easy to add the composition according to the invention into the wood, wherein it is possible to eliminate cracking and dimensional changes due to the drying of wood. Furthermore, this method can be used to improve the fire resistance and to provide at least a short-term preservation against microorganisms.

In connection with the treatment methods according to points 1 to 4, however, it is important to dry the wood well (for example, at a temperature from 40 to 80° C.), wherein the extra water absorbed in the wood during the process can be removed and the moisture content can be stabilized to a desired final level.

By the solution of the invention, it possible to facilitate the treatment of wood under winter conditions where the processing of frozen wood (for example, melting, impregnation, planning, painting, etc.) is problematic and constitutes an extra cost item.

In the following, the invention will be described in more detail by means of examples on the preservation of wood with the wood treatment composition according to the invention. The examples are intended to illustrate and not to limit the invention.

### EXAMPLES

### Leaching Tests Using Alkyd Emulsion as Anti-Leaching Agent

Leaching tests were performed under accelerated and modified EN 84 standard. The amounts of wood preservatives absorbed in to wood samples (retention kg/m³) were determined by calculated means and dry basis weighting (dry weights of the wood samples before and after impregnation and drying). The effectiveness of the wood preservatives against leaching was determined on the basis of the weight loss caused by the rinsing. Weights were determined by calculated means and by dry basis weighting.

| | Leaching out of the |
|---|---|
| Wood preservative | wood preservative % |
| 3 wt-% potassium formate (general information) | ca. 100 |
| 3 wt-% calcium formate | ca. 80 |
| 3 wt-% calcium formate + 3.0 wt-% silane | ca. 72 |
| 3 wt-% calcium formate + 0.001 wt-% PHMG | 62-85 |
| 3 wt-% calcium formate + 1.10 wt-% alkyd emulsion | 6-32 |
| of fatty acids (2.0 wt-% Synthalat AEM 700 TC) | |
| CCA wood preservative (general information) | <15 |

The wood preservative solution according to the invention (3 wt-% calcium formate +1.10 wt-% alkyd emulsion of fatty acid) remarkably reduced the leaching of the wood preservative compared to reference wood preservative containing hydrophobification agent (i.e. silane) or polymers (i.e. PHMG).

### Fungi Tests Using Aluminium Ion Containing Compound as Anti-Leaching Agent—Resistance to the Growth of Fungi on the Surface of Coatings

The test time of the evaluation method was four (4) weeks, the ability to have a coating to resist the growth of fungi on the surface. Wooden panels of Pines elliotti dimensioned 101×76×13 mm listed (twice) received two hands of the respective shows, applied with a brush with an interval of 24 hours between the respective hands. After the drying time needed to end the bodies were exposed to spores fungicides according to standards proposed by ASTM 3273-86 “Resistance to the growth of fungi on the surface of tropical paintings in the chamber.” The bodies were exposed to spores of the fungus following: Penicillum purpurogenum Aspergillus flavus, Aureobasidium pullulans Aspergillus terreus and Aspergillus niger Trichoderma viride.

After inoculation the bodies were incubated in tropical chamber for 28 days. On days 0 and 7 bodies undergo inoculations with the pool of fungi listed above at a concentration of 100,000,000 spores per millilitre.

### Features of the Camera Tropical

It is a sealed device capable of maintaining a relative humidity of 95 to 98% at a temperature of 90+/−2 Fahrenheit (ca. 32.2° Celsius). Under these conditions and post-inoculation, the bodies of evidence are continually exposed to spores of the fungus. Basically to hold in its interior a bed of water, it evaporates and condenses continuously, producing a rotation of the watery mass in different physical states, so as to maintain the fungal spores in continuous rotation in the atmosphere. The test method is extremely aggressive and saturated in humidity i.e. the wood treatment chemical without anti-leaching capability will immediately come out of the wood and no protection against fungi exists anymore.

### Sample A:

| | |
|---|---|
| Calcium formate (100%) | 9.5% |
| PHMG (20%) | 1.0% |
| Water | 89.5% |

Sample B (according to the invention):

| | |
|---|---|
| Calcium formate (100%) | 10% |
| PHMG (20%) | 5% |
| PAC i.e. polyaluminium chloride (18% Al₂O₃) | 10% |
| Formic acid was used to adjust pH to 4.0-4.2 | |
| The end product (the reaction product of PAC | |
| and formic acid) is polyaluminium formate. | |
| Water | 75% |

The polyaluminium formate (basic aluminium polyformate) formed after drying a hydrophobic network that avoids the leaching of the PHMG and the calcium formate. PHMG reacts with the calcium PHMG formate and from in-situ formed PHMG-formate.

The wood preservative solution according to the invention containing calcium formate and the aluminium ion containing compound remarkably reduced the leaching of the wood preservative and thus improved the fungi resistance compared to reference wood preservative containing only the polymer (i.e. PHMG).

1. A composition for treating wood-based material, comprising:
at least one C₁-C₇ monocarboxylic acid salt or C₁-C₇ monocarboxylic acid or a mixture thereof as active agent against deterioration of wood, alkyd emulsion of high unsaturated fatty acid content, and/or aluminum ion containing compound in the form of polyaluminum formate in a same aqueous liquid carrier as the C₁-C₇ monocarboxylic acid salt or C₁-C₇ monocarboxylic acid or a mixture thereof.

2. The composition according to claim 1, wherein the C₁-C₇ monocarboxylic acid salt is formate or sorbate of a mixture thereof.

3. The composition according to claim 1, said formate or sorbate is an alkali metal salt, an alkaline earth metal salt, an aluminum salt, or an ammonium salt or a mixture thereof.

4. The composition according to claim 3, wherein said formate is ammonium formate or calcium formate or a mixture thereof.

5. The composition according to claim 1, further comprising:
biocide.

6. The composition according to claim 1, wherein the alkyd emulsion of high unsaturated fatty acid content is in an amount of 0.05 to 10 wt-%.

7. The composition according to claim 1, wherein the aluminum ion containing compound comprises aluminum triformate, aluminum polyformate, aluminum sulfate, aluminum polysulfate, aluminum chloride, aluminum polychloride, aluminum phosphate or mixture thereof.

8. The composition according to claim 1, further comprising:
rheological auxiliary agents.

9. The composition according to claim 1, further comprising:
coloring agents.

10. The composition according to claim 1, further comprising:
fire retarding chemical based on phosphorus or nitrogen.

11. The composition according to claim 1, further comprising:
additional (auxiliary) active agents against deterioration of wood.

12. The composition according to claim 1, wherein the complexing agent comprises an organic chelator.

13. The composition according to claim 1, wherein the complexing agent comprises ethylenediaminetetra-acetic acid, nitrolotriacetic acid, n-hydroxyethyl-ethylenediaininetriacetic acid, diethylenetriaminepentaacetic acid, ethylediamine-di-o-hydroxyphenylacetic acid, diethanolglycine, ethanoldiglycine or salt thereof or 1-hydroxyethylidene,1,1-diphosphonic acid, ethylenediaminetetramethylenephosphonic acid, diethylenetriaiminepentamethylenephosphonic acid or salt thereof or a mixture thereof.

14. The composition according to claim 1, further comprising:
hydrophobification agent.

15. The composition according to claim 1, further comprising:
surfactants in a content of 0.01 to 30 wt-%.

16. The composition according to claim 1, further comprising:
oxidizing chemicals.

17. The composition according to claim 1, wherein the composition has a pH of 4 to 12.

18. A method for treating wood-based material, the method comprising: in which
bringing a treatment composition and the wood-based material into a contact with each other, wherein the treatment composition comprises at least one C₁-C₇ monocarboxylic acid salt or C₁-C₇ monocarboxylic acid or a mixture thereof as active agent against deterioration of wood, alkyd emulsion of high unsaturated fatty acid content, and/or aluminum ion containing compound in the form of polyaluminum formate in a same aqueous liquid carrier as the C₁-C₇ monocarboxylic acid salt or C₁-C₇ monocarboxylic acid or a mixture thereof.

19. The method according to claim 18, wherein the treatment is carried out by immersing, spraying, steaming, atomizing, brushing or hot isostatic pressing.

20. The method according to claim 18, wherein the treatment is performed in a wood processing line is one of a series of successive processing steps performed on timber or a wood object.

21. The method according to claim 20, wherein the treatment is carried out in a painting or surface treatment line of wood.

22. The method according to claim 20, wherein the treatment is carried out in connection with a final drying of wood by adjusting a final moisture content of the wood by the composition.

23. The method according to claim 20, wherein the treatment is carried out after planning the wood.

24. The method according to claim 20, wherein the treatment is carried out in a wood impregnation plant, for example by pressure impregnation.

25. The method according to claim 18, wherein the treatment is carried out as a surface treatment or painting for ready structures outdoors.

26. The method according to claim 18, wherein the treatment is performed on spruce or another tight grained wood type, into which CCA is poorly absorbable.

27. A wood-based material, comprising:
at least one C₁-C₇ monocarboxylic acid salt or C₁-C₇ monocarboxylic acid and alkyd polymer of high unsaturated fatty acid content and/or aluminum ion containing compound content as a result of treatment with a composition comprising at least one C₁-C₇ monocarboxylic acid salt or C₁-C₇ monocarboxylic acid or a mixture thereof as active agent against deterioration of wood, alkyd emulsion of high unsaturated fatty acid content, and/or aluminum ion containing compound in the form of polyaluminum formate in a same aqueous liquid carrier as the C₁-C₇ monocarboxylic acid salt or C₁-C₇ monocarboxylic acid or a mixture thereof.

28. Use of the composition according to claim 1 for the preservation and protection of wood-based material against any environmentally induced deterioration mechanism or a mixture thereof.

29. Use of the composition according to claim 28, wherein the environmentally induced deterioration mechanism is or is caused by wood-rotting fungi, surface mould, blue stain fungi, insects, termites, fire, dimensional changes, coloring changes or a mixture thereof.
